(19) United States
(12) Patent Application Publication
(10) Pub. No.: US 2001/0018014 A1
(43) Pub. Date: Aug. 30, 2001

(54) Self-locking nut

(76) Inventor: Katsuo Ito, Sapporo City (JP)

Correspondence Address: Irving Keschner, Suite 1150, 21515 Hawthorne Boulevard, Torrance, CA, 90503, US

(21) Appl. No.: 09/785,655

(22) Filed: Feb. 16, 2001

(30) Foreign Application Priority Data
Feb. 16, 2000 (JP) 2000-037450

(51) Int. Cl. F16B 39/22

(52) U.S. Cl. 411/288

(57) ABSTRACT

A double nut type self-locking nut that lends to easy machining of a small cross section area of crush section with uniform cut out surface by changing the shape of the cut out grooves in the main nut unit in order to provide a stable level of tightening torque at a certain level of shearing strength.

### BACKGROUND OF THE INVENTION

1. Field of the Invention

A self-locking nut that forms a small area of crush section by creating cut out grooves in the mid section of the nut to exert the effects of a double nut locking through two separated nuts whose aforementioned crush section has been sheared when a certain amount of tightening torque is applied on the nut.

2. Description of the Prior Art

Prior art locking nuts are illustrated in FIGS. 7-9. In particular, FIGS. 7 and 8 illustrate a locking nut having loop-shaped grooves 23 and 24 placed opposite each other on the outer and inner circumference in the mid section of the main nut unit 22, forming a cylindrical crush section 25 of uniform thickness. With this kind of structure it is difficult to develop a practical nut because of the difficulty in manufacturing the loop-shaped groove 24, particularly in the inner circumference area.

Referring to FIG. 9, the self-locking nut illustrated has loop groove 33 on the outer circumference surface of the main nut unit 32, with the inner circumference surface structured as cylindrical crush section 35 and formed by female screw 34. In such a structure, the shearing strength of the cylindrical crush section 35 is variable because the female screw 34 has a gradient and the placement position of the groove bottom of the female screw in relation to the cylindrical crush section 35 cannot be specified. Thus, the problem with this design is that the deviation in tightening torque is too large.

What is desired is to provide a locking nut that avoids the problems set forth in the prior art.

### SUMMARY OF THE PRESENT INVENTION

A pair of opposing cut out grooves are placed in the mid section of the main nut unit from the outer circumference surface toward the axis core, and the crush section formed extending to the direction of the radius between the cut out grooves. When the aforementioned pair of cut out grooves are placed slightly staggered toward the axis direction in the main nut unit, the shearing action by the required tightening torque splits the nut in two with the upper nut leaning toward the axis line by the additional tightening strength; because of this the nut exerts a more powerful locking action than a locking action of a simple double nut. Moreover, the aforementioned pair of cut out grooves can be place on the same flat surface that directly intersects with the axis line of the main nut unit. The inner edge of the aforementioned crush section preferably is designed to reach the female screw of the screw hole.

The present invention thus provides a double nut type self-locking nut, the required tightening torque being provided by changing the shape of the cut out grooves in the main nut unit, thus allowing easy machining of the crush section. The crush section has a substantially uniform and small section area and provides a relatively uniform level of shearing strength.

The self-locking nut of the present invention provides a locking function that is superior to a simple double nut through the locking effects of two nuts separated by the shearing section.

### DESCRIPTION OF THE DRAWING

For a better understanding of the invention as well as other objects and further features thereof, reference is made to the following description which is to be read in conjunction with the accompanying drawings wherein:

FIG. 1 is a front elevation view of the self-locking nut of the present invention;

FIG. 2 illustrates a top view of the nut shown in FIG. 1;

FIG. 3 is a cross-sectional view along line 3-3 of FIG. 1;

FIG. 4 illustrates the installation of the nut of FIG. 1 before the crush section is sheared;

FIG. 5 illustrates the self-locking nut of FIG. 1 installed with the crush section sheared;

FIG. 6 is a front elevational view of another embodiment of the self-lock nut of the present invention;

FIG. 7 is a front elevational view of a conventional self-locking nut;

FIG. 8 is a cross-sectional view along line 8-8 of FIG. 7; and

FIG. 9 is a front elevational view of another conventional self-locking nut.

### DESCRIPTION OF THE INVENTION

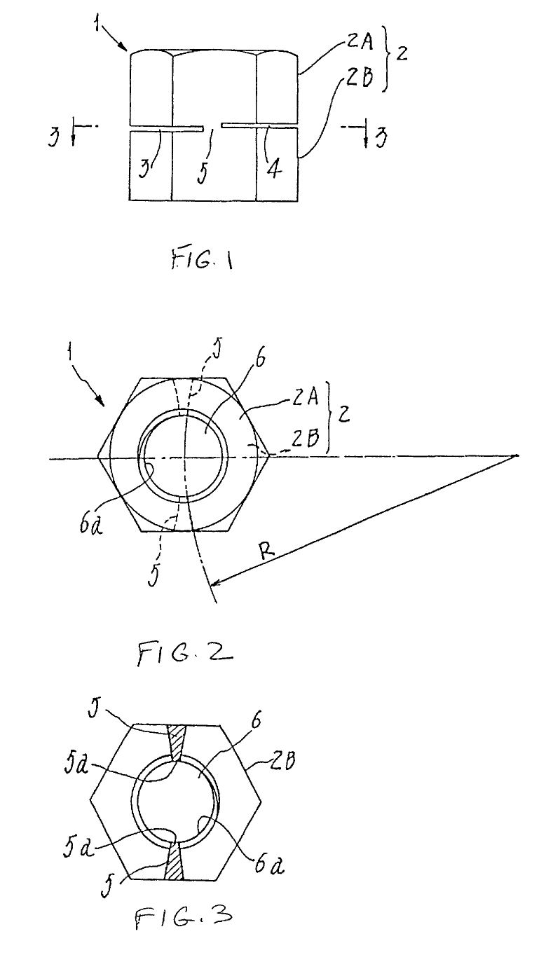

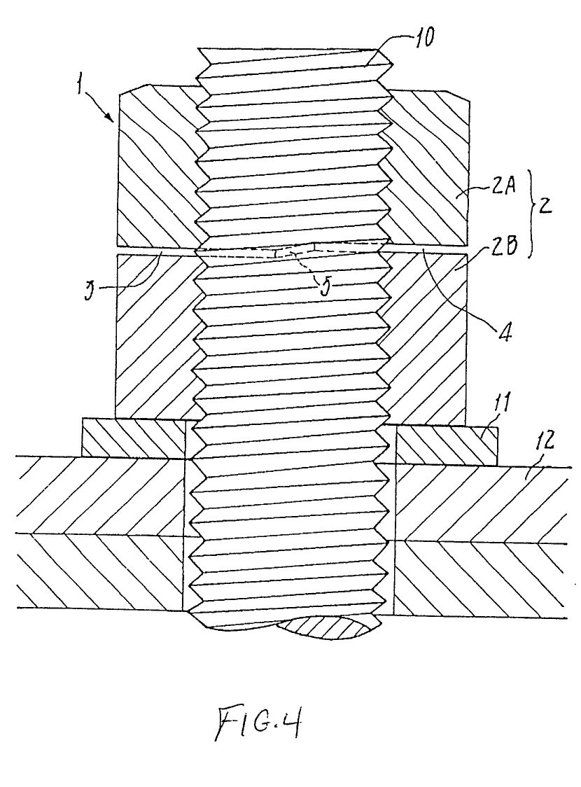

FIGS. 1-3 show self-locking nut 1 in accordance with the teachings of the present invention, nut 1 being longer than the conventional hexagonal nut. In the mid section of the main nut unit 2, a pair of cut out grooves 3 and 4 are cut opposing each other from the outer circumference surface to the axis core. The nut is separated into upper nut 2A and lower nut 2B, with both nuts 2A and 2B formed between cut out grooves 3 and 4, and mutually connected by two crush sections 5 that have oblong small cross sections stretching toward the radius direction. As shown in FIG. 1, cut out grooves 3 and 4 are placed so that they are slightly offset in the direction of the axis. Both grooves are placed on a flat surface directly intersecting the axis line of main nut unit 2. As it will be explained hereinafter, this enhances the locking effect. Specifically, in the event the measurement of main nut unit 2 is M12 and P1.5, the width of the cut out grooves 3 and 4 are approximately 0.5 mm and the offset toward the axis direction is approximately 0.5 mm. Cut out grooves 3 and 4 are cut in an arc shape with a radius of R, as shown in FIG. 2, by using a cutting tool such as a thin milling cutter. By adjusting the cutter's diameter and its cutting depth, a crush section 5 with an arbitrary cross section can be easily machined. Also, it is desirable to have inner edge 5a of the crush section 5 reaching the female screw 6a of screw hole 6 of the main nut unit 2.

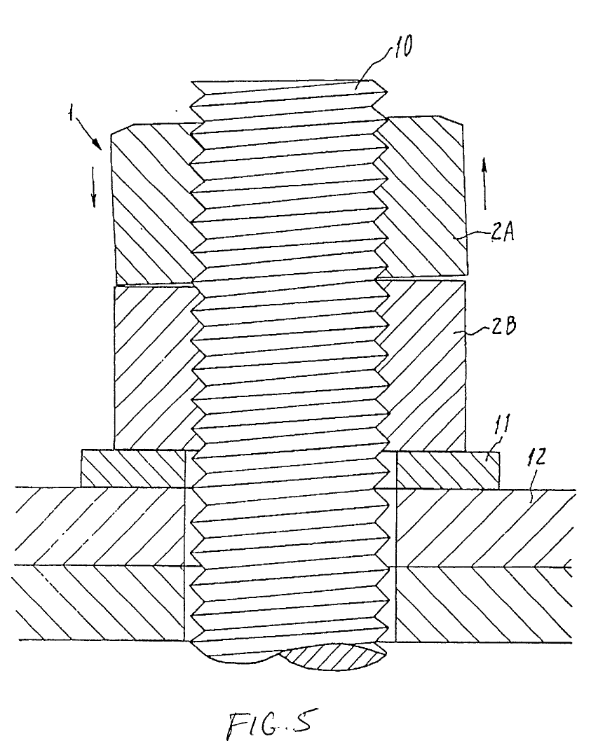

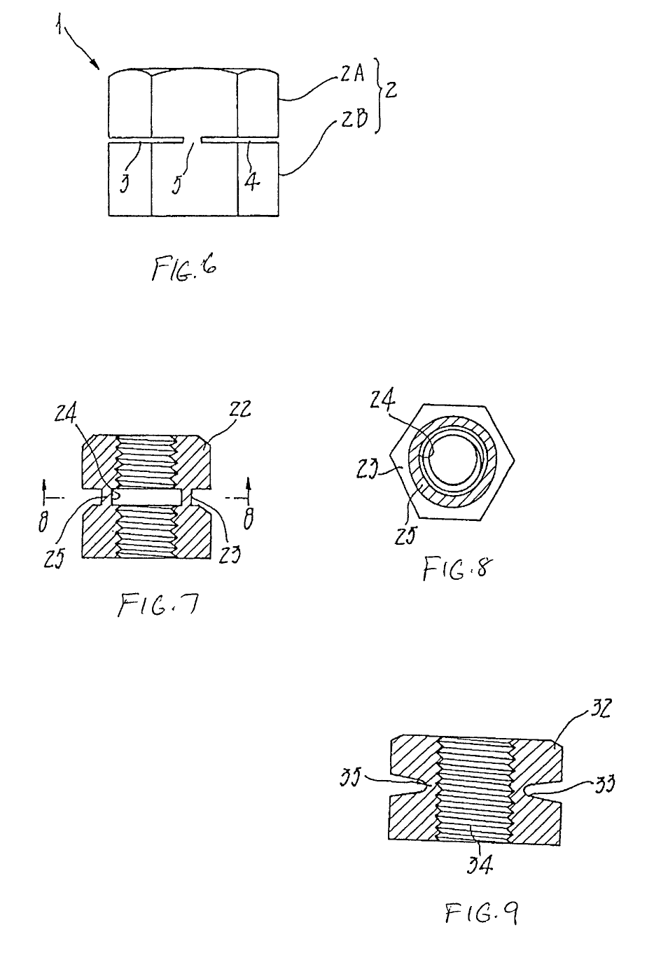

FIGS. 4 and 5 illustrate the installation of self-locking nut 1. FIG. 4 shows the said self-locking nut 1 screwed together to the male screw section 10 of the bolt, tightening of the bolt joining material 12 via washer 11 at the point where the crush section 5 is about to be sheared. If a screwing tool (not shown) is placed on the upper nut 2A under this condition and tightens it beyond the designated tightening torque, the crush section 5 is sheared, allowing the nut to be tightened in a way that the double nuts of the separated upper nut 2A and lower nut 2B exert locking action. If the upper nut 2A is further tightened by about 90 degrees in this tightened state, the upper nut 2A leans, or tilts, toward the axis line, as shown in FIG. 5, because the cut out grooves 3 and 4 placed to form crush section 5 are slightly staggered toward the axis, applying bending stress to the bolt's male screw section 10. Thus, a stronger locking action than that of a simple double nut is exerted.

In the above example, the pair of cut out grooves 3 and 4 that form crush section 5 were offset in the direction of the axis. However, the cut out grooves 3 and 4 may be placed opposing each other on a same flat surface that directly intersects the axis line of main nut unit 2, as shown in FIG. 6. In this case, when crush section 5 is sheared by the designated tightening torque, the nut is tightened by the double nut locking action of the separated upper nut 2A and lower nut 2B.

The present invention provides a relatively simple technique for machining a crush section that has a uniform cross section area compared to a conventional self-locking nut with cylindrical crush section, giving a double nut type self-locking nut that features a uniform level of tightening torque.

While the embodiment has been described with reference to its preferred embodiment, it will be understood by those skilled in the art that various changes may be made and equivalents may be substituted for elements thereof without departing from the true spirit and scope of the invention. In addition, modifications may be made to adapt a particular situation or material to the teachings of the invention without departing from its essential teachings.

What is claimed is:

1. A self-locking nut characterized by a pair of opposing cut out grooves placed in the mid section of the nut toward the axis core from the external circumference surface, and with a crush section formed in the direction of the radius between the cut out grooves.

2. The self-locking nut of claim 1 in which the aforementioned pair of cut out grooves are slightly staggered in the direction of the axis.

3. The self-locking nut described in claims 1 or 2 where the inner edge of the previously described crush section extends to the female screw of the screw hole of the aforementioned nut.
